(19) United States
(12) Patent Application Publication
(10) Pub. No.: US 2009/0322888 A1
(43) Pub. Date: Dec. 31, 2009

(54) INTEGRATED CIRCUIT FOR DETECTING MOVEMENTS OF PERSONS

(76) Inventors: Alexander Wuerz-Wessel, Stuttgart (DE); Jens Schick, Herrenberg (DE)

Correspondence Address: KENYON & KENYON LLP, ONE BROADWAY, NEW YORK, NY, 10004, US

(21) Appl. No.: 12/303,522

(22) PCT Filed: Sep. 14, 2007
(86) PCT No.: PCT/EP2007/059713

§ 371 Date: May 19, 2009

(30) Foreign Application Priority Data
Nov. 14, 2006 (DE) 102006053837.4

(51) Int. Cl. H04N 5/225

(52) U.S. Cl. 348/207.11; 348/E05.024

(57) ABSTRACT

An integrated circuit processes image data of a video camera by determining the optical flow and uses this to calculate output data that are either a measure for the position and/or movement of body parts of persons, or that represent and code gestures of persons. Furthermore, an electronic data-processing system, a method, and a computer program are provided.

### FIELD OF INVENTION

The present invention relates to an integrated circuit, an electronic data-processing system, a method for calculating output data of an integrated circuit, and a computer program.

### BACKGROUND INFORMATION

Personal computers (PCs) have a keyboard and a mouse for input. The orientation in the program or the feedback occurs via a graphic interface on a screen, in part together with a loudspeaker output. It is a disadvantage that in tight work spaces, like the seat in an airplane, the mouse cannot be moved freely, and it is also difficult to operate the keyboard.

Increasingly, video games are attracting more and more followers and enjoying ever increasing popularity. Video games are implemented both on personal computers and on game consoles. The input preferably occurs via keyboard, the mouse, or joysticks. It is a disadvantage that the use of these instruments ties the player to the device.

A game console based on a personal computer is known from the German published patent application DE 195 14 877 A1. Interfaces for joysticks or track balls are provided for operation. Furthermore, for the output, an interface for a screen is provided via which sound and image data are output.

### SUMMARY OF THE INVENTION

The integrated circuit described below has an advantage that the determination of the optical flow of image data and the integration of this algorithm in an integrated circuit allows for a cost-effective, precise, and quick ascertainment of output data that provide a measure for the position and/or movement of body parts of a person and/or represent the gestures of the person.

It is particularly advantageous if the first unit, which implements the algorithm for determining the optical flow, the stereo disparities, and/or the symmetry accumulations, is hardwired since in this way it is possible to optimize the integrated circuit so that it operates particularly quickly and efficiently. The programmable second unit, in which the output data is calculated, has the advantage that it allows for an application-specific and function-specific adjustment, so that the same integrated circuit may be used in many application areas.

It is furthermore advantageous that the output data encode sign language, since in this manner a simple platform for communication with electronic data-processing systems is provided for people who are deaf or seriously hearing-impaired.

The advantages of the integrated circuit described above are also accordingly valid for the electronic data-processing system, the method, and the computer program.

Further advantages result from the description of exemplary embodiments below with reference to the figures.

### BRIEF DESCRIPTION OF THE DRAWINGS

FIG. 1 illustrates an electronic data-processing system according to the present invention.

FIG. 2 illustrates an integrated circuit according to the present invention.

FIG. 3 illustrates a person in lateral view.

FIG. 4 illustrates a person in front view.

### DETAILED DESCRIPTION

Below, an integrated circuit is described, the integrated circuit processing video-camera image data by determining the optical flow and using this to calculate output data that either provide a measure for the position and/or the movement of body parts of persons, or represent and encode gestures of persons. Furthermore, an electronic data-processing system, a method, and a computer program are described.

The following describes a high-resolution measurement of the gestures of persons in a close-up stereo image for controlling a personal computer or a game console. The video camera is implemented as a stereo camera and is disposed above the screen and monitors the space in front of the personal computer. In the preferred exemplary embodiment, the position of the person's fingers, hands, arms, torso, legs, feet, and/or head, including their rotations, are ascertained from the video-camera image data and used for input as an alternative to the mouse, keyboard, or joystick. For this purpose, algorithms are used to measure the optical flow, stereo disparities, and/or symmetry accumulations. In the preferred exemplary embodiment, this input of information via an optic channel serves to give a player of a video game a greater possibility to intervene and thus to impart a higher gaming value. These possibilities to intervene are used to control a virtual player or another video game object, such as a car, for example.

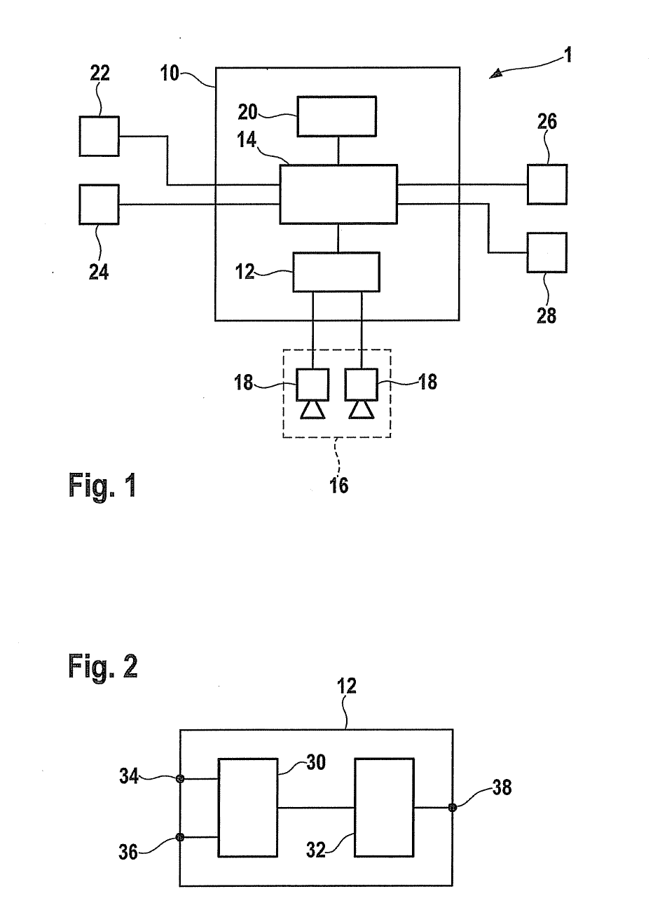

FIG. 1 shows an electronic data-processing system 1 of the preferred exemplary embodiment, made up of a personal computer 10 (PC), an integrated circuit 12, and a stereo camera 16. In one variant, a notebook or a game console is used as an alternative to personal computer 10. Personal computer 10 includes a processor 14 for processing data, a memory 20 for storing data, and integrated circuit 12. Processor 14 is connected via interfaces to a mouse 22 and a keyboard 24 as input units, additional electronic components, such as interface modules, possibly being interposed. Furthermore, the processor is connected via interfaces to a loud speaker 26 and a screen 28 as output units, additional electronic components, such as interface modules, possibly being interposed. An input of processor 14 is additionally connected to an output of integrated circuit 12. The integrated circuit is in turn connected to a stereo camera 16, additional electronic components, such as interface modules, possibly being interposed. Stereo camera 16 is made up of two video cameras 18 that essentially record the same scene. Video cameras 18 are disposed next to each other and their optical axes are essentially parallel so that video cameras 18 indeed record essentially the same scene, but from a slightly different viewing angle. In the preferred exemplary embodiment, stereo camera 16 is disposed above screen 28 and monitors the region in which the operator of personal computer 10 is located. Stereo camera 16 uses both video cameras 18 to generate image data and transmits these to integrated circuit 12. The structure of integrated circuit 12 is explained in more detail below with the aid of FIG. 2. On the one hand, the operating system of personal computer 10 is stored in memory 20 of electronic data-processing system 1. On the other hand, memory 20 is used to store business application programs, such as word processing programs, on the one hand, and to store video-game software programs, on the other hand. In the preferred exemplary embodiment, electronic data-processing system 1 is used both for business applications and for video games.

Integrated circuit 12 is used to calculate the movements and distances of objects that are located in the region recorded by stereo camera 16. If, for example, a person in the recording range of stereo camera 16 lifts a hand, then the hand is detected through the movement and measured through a stereo evaluation, the resolution enabling the separate measurement of fingers. Integrated circuit 12 simultaneously detects all of the body parts of the persons located in the visual range of stereo camera 16 and interprets their movement, integrated circuit 12 providing output data that are a measure for the position and/or movement of body parts of a person, and/or represent the gestures of the person, at its output to processor 14. Integrated circuit 12 is thus configured such that it provides pure position and/or movement data on the one hand, and on the other hand interpreted data that encode a gesture of the person.

FIG. 2 shows integrated circuit 12, made up of a first unit 30 and a second unit 32. Integrated circuit 12 includes two inputs 34 and 36 for connecting two video cameras 18 of a stereo camera 16, and an output 38. In the preferred exemplary embodiment, integrated circuit 12 is an ASIC (e.g., “application-specific integrated circuit”). An ASIC is an electronic circuit that is implemented as an integrated circuit. In one variant of the preferred exemplary embodiment, instead of the ASIC, an FPGA (e.g., “field programmable gate array”) is used and denotes a freely programmable logic circuit. What both variants have in common is that integrated circuit 12 is made up of two logic units 30, 32. First unit 30 is hardwired and not programmable. This first unit 30 calculates preprocessed image data by determining the optical flow from the image data of the stereo camera. In the preferred exemplary embodiment, first unit 30 additionally calculates stereo disparities and/or symmetry accumulations. Altogether, first unit 30 calculates preprocessed image data and thereby performs a data reduction. The preprocessed image data are passed on to second unit 32. In contrast to first unit 30, second unit 32 is characterized by the fact that second unit 32 is programmable. In the second unit, it is determined in an application-specific manner which output data second unit 32 calculates from the preprocessed image data. The output data are a measure for the position and/or the movement of body parts of a person and/or represent the gestures of the recorded person. These output data are provided at output 38 of integrated circuit 12.

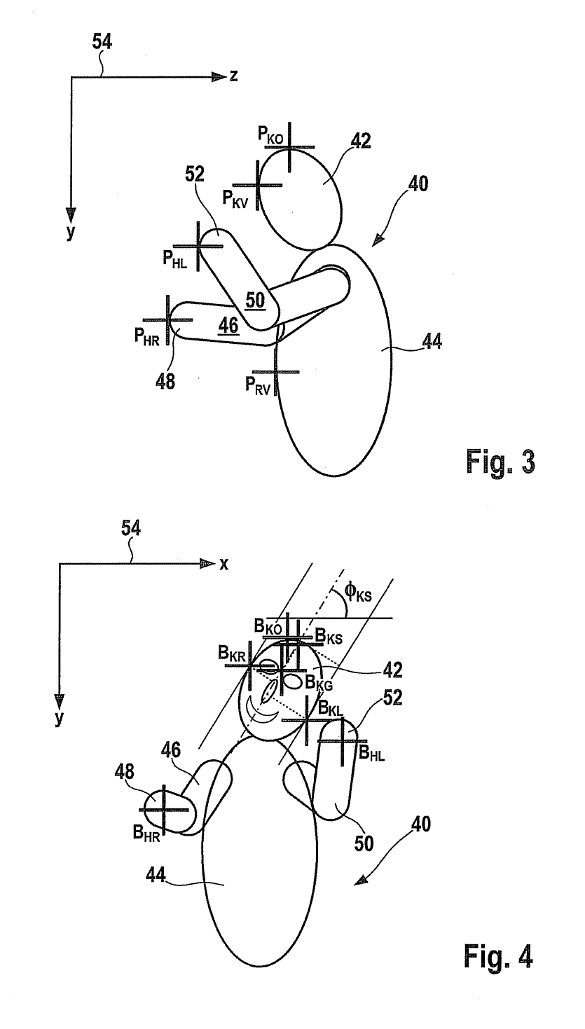

FIG. 3 illustrates schematically, in left lateral view, a person 40 recorded by the video cameras in order to explain the output data that are a measure for the position and/or movement of body parts of persons 40 and that are provided by the integrated circuit at the output. Person 40 includes a head 42, a torso 44, a right arm 46 having a right hand 48, and a left arm 50 having a left hand 52. Furthermore, FIG. 3 shows a coordinate system 54 having a y and a z axis. In FIG. 3, crosses chart some points that are output data of the integrated circuit and that indicate positions of body parts 42, 44, 48, 52 of person 40:

P_{RV}=(z) of the foremost spatial point of torso 44
P_{HR}=(x,y,z) of the foremost spatial point of right hand 48
P_{HL}=(x,y,z) of the foremost spatial point of left hand 52
P_{KV}=(z) of the foremost spatial point of head 42
P_{KO}=(y) of the top-most spatial point of the head

FIG. 4 illustrates schematically, in front view, a person 40 recorded by the video cameras in order to explain the output data that are a measure for the position and/or movement of body parts of persons 40 and that are provided by the integrated circuit at the output. Person 40 includes a head 42, a torso 44, a right arm 46 having a right hand 48, and a left arm 50 having a left hand 52. Furthermore, FIG. 4 shows a coordinate system 54 having an x and a y axis. In FIG. 4, crosses chart some points that are output data of the integrated circuit and that indicate positions of body parts 42, 44, 48, 52 of person 40:

B_{HR}=(x_{b},y_{b}) of the foremost spatial point of right hand 48
B_{HL}=(x_{b},y_{b}) of the foremost spatial point of left hand 52
Φ_{KS}=angle of the axis of symmetry in the image
B_{KG}=(x_{b},y_{b}) as picture elements of the face reference
B_{KO}=(x_{b},y_{b}) of the top-most spatial point of head 42
B_{KS}=(x_{b},y_{b}) of the point on the axis of symmetry closest to B_{KO}

Furthermore, in the preferred exemplary embodiment, additional output data are calculated from the positions of body parts 42, 44, 48, 52 of person 40 shown in FIGS. 3 and 4 and are provided at the output of the integrated circuit:

I_{KR}=distance between the right-most point of head 42 B_{KR} and the axis of symmetry in the image
I_{KL}=distance between the left-most point of head 42 B_{KL} and the axis of symmetry in the image
I_{KO}=distance between points B_{KS} and B_{KG}
M_{HL}=(X_{HL}, Y_{HL}, Z_{HL}−Z_{RV})→measures for the relative position of left hand 52
M_{HR}=(X_{HR}, Y_{HR}, Z_{HR}−Z_{RV})→measures for the relative position of right hand 48
M_{GV}=(Z_{KV}−Z_{RV})→measure for the forward speed
M_{GS}=(Φ_{KS})→measure for the lateral speed
M_{GR}=(0.5−I_{KL}/(I_{KL}+I_{KR}))→measure for the body turn
M_{GH}=(y_{KO}(k)−y_{KO}(k−1))→measure for the jump
M_{BR}=(I_{KO}/(I_{KL}+I_{KR}))→measure for the direction of view

Furthermore, in the preferred exemplary embodiment, additional output data are calculated in the integrated circuit from the image data of the video cameras by determining the optical flow, which output data provide a measure for the position and/or movement of body parts of the person:
foot position
bending angle between the foot and the lower leg
knee position
bending angle between lower and upper leg
solid angle of the upper leg
bending angle between upper leg and body
solid angle of the body
angle and positions of fingers and toes

The following illustrates the calculation of output data that represent the gestures of the person and thus encode the gestures:

The raising of a finger of a hand of the person means a starting condition, the lowering of the finger a stop. Thus, the gesture of moving this finger is an alternative to the mouse. An input confirmation comparable to the keyboard “enter” or a click of the right mouse button is generated via the abrupt movement of the finger and calculated by the integrated circuit. When the movement and measurement of the remaining body parts are included and combined, the input variety is nearly unlimited.

Furthermore, the integrated circuit calculates output data that are suitable for controlling virtual objects from video games, such as figures, games, and cars. For this purpose, in the preferred exemplary embodiment, the programmable second unit of the integrated circuit applies the following rules for encoding the recorded gestures of the person:

Movement
Coding: the virtual figure is standing
   No movement of the torso of the person ->no movement of the virtual figure
Coding: the virtual figure is walking
   Change in the position and angle of both upper legs of the person alternately->the frequency determines the speed of the virtual figure.
Coding: the virtual figure is running
   Springy walking, but with simultaneous evaluation of the vertical movement of the torso of the person->the frequency determines the speed of the virtual figure.
Coding: the virtual figure is jumping
   Strong vertical movement with the upper legs of the person positioned parallel to each other->strength of the vertical movement determines strength of the jump of the virtual figure.

Rotation
Coding: Rotation of the vertical axis of the virtual figure
   Rotation of the head around the vertical axis of the person->rotational position of the head corresponds to the rotational speed of the virtual player Rotational speed of head of the person->corresponds to rotational acceleration of the virtual figure Person's face in direction of video camera->means standstill of the rotation of the virtual figure (measurement of the rotational angle of the head through the distance between the head's center axis and the face's axis of symmetry, face is the sum of the features of eye, nose, and mouth, measurement of the rate of rotation of the head through the horizontal optical flow in the face less the displacement speed of the head's center axis)
Coding: nodding of the virtual figure
   Rotation of the head around its horizontal axis, rotational position of the head corresponds to the direction of view of the virtual figure, (measurement of the center of the face relative to the top of the head, calibration at the beginning of the game)
Coding: Staggering of the virtual figure
   Rotation of the head around the axis of the person toward the front->rotational position of the head corresponds to the quick sideways dodging of the virtual figure (measurement of the direction of the face symmetry axis in the image)

Actions, Communication
Coding: Positioning of virtual devices
   Position of the hands of the person in space for positioning virtual devices (weapons, shields, tools, gearshift levers, . . . ) relative to the body of the virtual figure, also in combination of both hands (for example, in the case of a virtual steering wheel)
Coding: Orientation of virtual devices
   Direction of the person's thumb for orienting the virtual devices. Position and solid angle of the person's feet for controlling virtual vehicle pedals (clutch, brake, gas)
Coding: Activation of the devices
   Number and movement of the extended fingers of the person for activating these devices or for communication with another player.

Furthermore, in the preferred exemplary embodiment, it is provided that a scene change and/or a switchover of devices is carried out by combining gestures into a pantomime.

In summary, the recording of the person by video cameras, the processing of image data by the integrated circuit and thus the supply of output data that represent and encode the gestures of the person, and the assigning of the recorded gestures of the person to behavior elements of the virtual objects of the video game make it possible for the person who is recorded by the video camera to control and monitor these virtual objects in the areas of movement (standing, walking, running together with the speeds, jumping together with its strength), rotation (rotation together with its rotational speed around the vertical axis, nodding axis, and staggering axis), actions and communication (actions using both arms independently of each other, activation of devices, communication with partners).

In one variant of the preferred exemplary embodiment, the integrated circuit provides output data that encode the gestures of the widely used sign language. For this purpose of encoding, gestures of hands, in conjunction with facial expression and the shape of the mouth of the person, are recorded by video cameras, and evaluated by the integrated circuit and provided as output data. This is preferably evaluated by the integrated circuit in the context of posture.

In one variant, implements such as a baton and/or a dumbbell, which are used by the person, are used to improve the calculation. This contributes in particular to an improved fine measurement of the hand movements, since their position may be measured more exactly because the form and color of the implements are known to the integrated circuit.

A further variant provides that the integrated circuit and the video camera replace the function of the keyboard. This is achieved in that the ten fingers of the person are simultaneously monitored by the video cameras. To this end, both hands of the person are held in front of the video cameras. By bending one finger or the combination of a plurality of fingers, the keyboard is completely emulated by the integrated circuit.

The described integrated circuit, the data-processing system, the method, and the computer program are not restricted to the area of personal computers and video games, but rather may also be used in industrial control and also in screen-free systems. In this context, the feedback for the input occurs preferably through other media, for example, loud speakers. The use of the integrated circuit in the area of driver assistance systems for recording pedestrians in the surroundings of a motor vehicle by using a video camera is particularly advantageous. Furthermore, as an alternative or in addition to the stereo camera, an individual video camera is used.

1-10. (canceled)

11. An integrated circuit, comprising:
at least one input configured to connect a video camera and receive video-camera image data;
a first unit configured to calculate preprocessed image data using the received image data by determining an optical flow;
a second unit configured to calculate output data using the preprocessed image data, the output data at least one of a) being a measure for at least one of a position and a movement of body parts of a person and b) representing gestures of the person; and
at least one output configured to provide the output data.

12. The integrated circuit according to claim 11, wherein at least one of the first unit is hardwired and the second unit is programmable.

13. The integrated circuit according to claim 11, wherein the integrated circuit is at least one of an ASIC and an FPGA.

14. The integrated circuit according to claim 11, wherein the output data encode sign language.

15. An electronic data-processing system, comprising:
an integrated circuit, comprising:
at least one input configured to connect a video camera and receive video-camera image data;
a first unit configured to calculate preprocessed image data using the received image data by determining an optical flow;
a second unit configured to calculate output data using the preprocessed image data, the output data a) being a measure for at least one of a position and a movement of body parts of a person and b) representing gestures of the person; and
at least one output configured to provide the output data; and
at least one video camera.

16. The electronic data-processing system according to claim 15, wherein the video camera is a stereo camera.

17. The electronic data-processing system according to claim 15, wherein the data-processing system includes at least one of a keyboard, a mouse, a screen, and a loudspeaker.

18. A method for calculating output data of an integrated circuit, the integrated circuit including at least one input configured to connect a video camera and receive video-camera image data; a first unit configured to calculate preprocessed image data using the received image data by determining an optical flow; a second unit configured to calculate the output data using the preprocessed image data, the output data at least one of a) being a measure for at least one of a position and a movement of body parts of a person and b) representing gestures of the person; and at least one output configured to provide the output data, the method comprising:
calculating the preprocessed image data using the received image data by determining the optical flow; and
calculating the output data using the preprocessed image data, the output data representing the gestures of the person.

19. The method according to claim 18, further comprising:
controlling video-game objects as a function of the output data.

20. A computer program having program-code means which, when executed by a processor, performs a method for calculating output data of an integrated circuit, the integrated circuit including at least one input configured to connect a video camera and receive video-camera image data; a first unit configured to calculate preprocessed image data using the received image data by determining an optical flow; a second unit configured to calculate the output data using the preprocessed image data, the output data at least one of a) being a measure for at least one of a position and a movement of body parts of a person and b) representing gestures of the person; and at least one output configured to provide the output data, the method comprising:
calculating the preprocessed image data using the received image data by determining the optical flow; and
calculating the output data using the preprocessed image data, the output data representing the gestures of the person.
